(19) United States
(12) Patent Application Publication
(10) Pub. No.: US 2022/0156635 A1
(43) Pub. Date: May 19, 2022

(54) Machine Learning Prediction For Recruiting Posting

(71) Applicant: SAP SE, Walldorf (DE)

(72) Inventor: Antoine Feuillet, Margency (FR)

(21) Appl. No.: 16/953,121

(22) Filed: Nov. 19, 2020

(51) Int. Cl. G06N 20/00; G06Q 10/10; G06K 9/62

(52) U.S. Cl. CPC G06N 20/00; G06K 9/6256; G06Q 10/1053

(57) ABSTRACT

The present disclosure provides systems and methods for predicting a date and time to post job advertisements using a prediction model generated by a machine learning algorithm such that candidates are more likely to view the job posting. The prediction model is trained using a machine learning algorithm based on a first split of a plurality of post records for job postings and view records corresponding to the first split of the post records. The post records include a post date, a post time, a country indicator, and a segment indicator for each of the job postings. The view records including a view date and a view time for each of the plurality of job postings. The predictions may be provided via an API.

### BACKGROUND

The present disclosure pertains to machine learning and in particular to predicting dates and times for posting jobs using a machine learning model based on a regression algorithm.

Job recruiters post thousands of job advertisements every day on job board websites to reach candidates and find the best ones. However, recruiters may not have significant insight on the best time to post each specific job such that more candidates will see the posting, which would help to ensure that better candidates are found for the job. Some recruiters may simply post a job advertisement after it has been written. However, posting a job without any guidance on timing of when candidates might view the posting may result in a smaller number of candidates being reached which is problematic because the job market is competitive, with numerous jobs being posted every hour. Posting a job advertisement at a time when candidates are not likely to be viewing the advertisement may result in fewer or no qualified candidates applying for that job.

Studies have been performed in order to better understanding when candidates apply to jobs. Statistics from these studies show that there may be better times to post jobs in order to reach candidates. For instance, a study by SmartRecruiters suggests that more candidates submit applications to jobs on Tuesday compared to other days of the week, and that more candidates submit applications in the middle of the day compared to early morning and night. Buss, Jason. “Right Place, Right Time: The Data Behind Hiring Success.” SmartRecruiters, Apr. 3, 2015, https://www.smartrecruiters.com/blog/right-place-right-time-the-data-behind-hiring-success/. Another study by LinkedIn found that fall was a better time to hire compared to other seasons. Chimka, Andrew, “Is fall the best season to hire?” LinkedIn, Sep. 23, 2019, https://www.linkedin.com/profinder/blog/the-best-time-to-hire.

Statistics on job applications may be used to direct a recruiter's timing for posting job advertisements. However, statistics are limited in their accuracy for prediction because statistical models merely define relationships between input and output numerical variables. That is, models based on statistical inference characterize the relationship between the data and the outcome variable, they are not intended to be used to make predictions about future data. Given that statistical models define relationships between input and output values, they consequently fail to account for changes in how candidates apply to jobs over time. That is, statistical models cannot account for up or down trends or curves in the data over time.

There is a need for improved systems and methods for determining the best time to post job advertisements in order for more candidates to view the posting. The present disclosure addresses these issues and others, as further described below.

### SUMMARY

One embodiment provides a computer system comprising one or more processors and one or more machine-readable medium. The one or more machine-readable medium are coupled to the one or more processors. The one or more machine-readable medium store computer program code comprising sets of instructions executable by the one or more processors. The instructions are executable by the one or more processors to obtain a prediction request including a request date, a request time, a request day-of-year, a country indicator, and a business segment indicator. The instructions are further executable by the one or more processors to determine a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records include a view date and a view time for each of the plurality of job postings.

Another embodiment provides one or more non-transitory computer-readable medium storing computer program code comprising sets of instructions. The computer program code comprising instructions to obtain a prediction request including a request date, a request time, a request day-of-year, a country indicator, and a business segment indicator. The computer program code further comprises sets of instructions to determine a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records include a view date and a view time for each of the plurality of job postings.

Another embodiment provides a computer-implemented method. The method includes obtaining a prediction request including a request date, a request time, a request day-of-year, a country indicator, and a business segment indicator. The method further includes determining a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records including a view date and a view time for each of the plurality of job postings.

The following detailed description and accompanying drawings provide a better understanding of the nature and advantages of the present disclosure.

### BRIEF DESCRIPTION OF THE DRAWINGS

FIG. 1 shows a diagram of a recruiting system in communication with a recruiter computer device and a plurality of job posting websites, according to an embodiment.

FIG. 2 shows a diagram of a recruiter computer device, a job posting webserver, and components of a recruiting system, according to an embodiment.

FIG. 3 shows a flowchart of a method for training a machine learning model, predicting job post view dates and times, and updating the model, according to an embodiment.

FIG. 4 shows a diagram of training, testing, and validating of a machine learning model, according to an embodiment.

FIG. 5 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein.

As mentioned above, statistics on job applications may be used to direct a recruiter's timing for posting job advertisements. However, statistics are limited in their accuracy when for prediction because statistical models merely define relationships between input and output numerical variables. That is, models based on statistical inference characterize the relationship between the input data and the outcome variable, they do not make predictions about future data. Given that statistical models define relationships between input and output values, they consequently fail to account for changes in how candidates apply to jobs over time. That is, statistical models cannot account for up or down trends or curves in the data over time.

The present disclosure provides systems and methods for predicting a date and time to post job advertisements using a prediction model generated by a machine learning algorithm such that candidates are more likely to view the job posting (i.e., the job advertisement that has been posted to or published on a website, job board, or other channel). In contrast to statistical models, which generally have parameters evaluated based on their confidence or significance, machine learning algorithms train the model based on a first split of the input data and then test the model against a second split of the input data, different from the first split. The training of the model determines the model parameters, and the testing of the model is used to determine parameters of the machine learning algorithm itself (e.g., hyperparameters). Testing the model using a split of the input data helps to ensure that the prediction model does not become overfit to the split of data used for training.

Features and advantages of training a model using machine learning algorithms is that the machine learning model may accurately be used for prediction, unlike statistical models which merely reflect the characteristics of the input data and may have poor prediction accuracy due to overfitting, for example. Other features and advantages of using a prediction model trained using a machine learning algorithm, compared to statistical models, is that the prediction model may account for changes overtime, thereby accounting for upwards or downwards trends. Further features and advantages of the present disclosure are described below.

As further described below, a recruiting system may provide a prediction application programming interface (API) that returns a predicted date and predicted time for posting a job based on a given date, time, day of year, country, and business segment. Recruiters may send requests or queries to the API and then post jobs directly on a job board or they may access the recruiting system and use it to post their jobs. Regardless of the method for posting the job, the recruiter may post the job at the best time for candidates to view the job posting based on the results of the machine learning prediction model. The recruiting system, the training and testing of the machine learning prediction model, and the prediction API are described in further detail below.

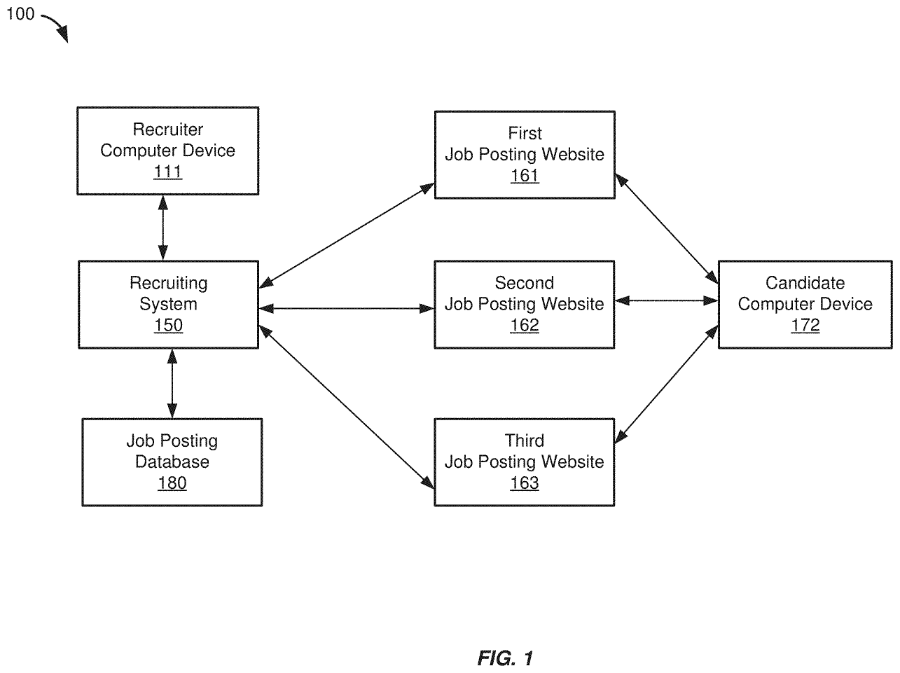

FIG. 1 shows a diagram 100 of a recruiting system 150 in communication with a recruiter computer device 111 and a plurality of job posting websites 161, 162, 163, according to an embodiment. The recruiting system 150 may be a server computer or a system of multiple server computers. The recruiting system 150 may provide a platform including websites and applications enabling job recruiters to post job advertisements to multiple job boards, websites, and other channels, track job postings, and manage job postings, for example.

A job recruiter may access the recruiting system 150 using a recruiter computer device 111. The recruiter computer device 111 may be a personal computer, a desktop computer, a laptop, a tablet, a smartphone, or a mobile device, for example. The recruiter computer device 111 may access and communicate with the recruiting system 150 over a network, such as the Internet or an intranet. As such, the recruiter computer device 111 operates as a client and may be referred to a client computer. While one recruiter computer device 111 is shown in FIG. 1, the recruiting system 150 may communicate with and be accessed by hundreds or thousands of different computer devices used by different recruiters and other users.

The recruiter system 150 may be configured to access a job posting database 180. In some embodiments, the job posting database 180 may be queried via a database system including one or more database servers. In some embodiments, the job posting database 180 may be part of the recruiting system 150. The job posting database 180 may comprise data records on thousands or millions of job postings. For example, the records stored in the job posting database 180 may include information such as a date of the job posting (e.g., the date that the job advertisement was posted on a job board, website, or other channel), a time of the job posting (e.g., the time that the job advertisement was posted on a job board, website, or other channel), a day-of-the-year (e.g., which of the 365 days of the year that the job was posted), a country indicator (e.g., an indicator or identifier of which country the job being posted is in or which country the job board, website, or other channel is in or represents), and a business segment indicator (e.g., a name, label, or identifier of the industry or business area that the job being advertised is in). The information on job posting views (e.g., view date and view time) stored in the job posting database 180 may be based on a token provided in a Uniform Resource Locator (URL) of the corresponding job posting, or it may be a token associated with an image file (e.g., an image at a particular URL), or the view information may be obtained from the job posting website or job board used to post the particular job advertisement.

The recruiting platform 150 may be configured to access and communicate with a first job posting website 161, a second job posting website 162, and a third job posting website 163. While three job posting websites are shown in FIG. 1, the recruiting system 150 may access and be in communication with hundreds or thousands of job posting websites, job boards, or other channels for posting job advertisements. Each of the first, second, and third job posting websites 161, 162, 163 may be hosted by a webserver, or by different webservers, for example. The job posting websites may be operated by third parties separate from an organization operating the recruiting system 150, for example. In some embodiments, one or more of the job posting websites may be hosted by the recruiting system 150 directly. The first, second, and third job posting websites 161, 162, 163 may enable candidates to browse or search job advertisements. Searches may be performed according to location, business segment, salary, and other considerations. The first, second, and third job posting websites 161, 162, 163 may present the job postings in order with the most recent postings being shown first at the top of the website. As such, it is advantageous for a job posting to have been posted more recently since it will be more likely to be viewed by the candidates browsing or searching the job posting websites.

The candidates may access the first, second, and third job posting websites 161, 162, 163 and other job boards and channels using a candidate computer device 172. The candidate computer device 172 may be a personal computer, a desktop computer, a laptop, a tablet, a smartphone, or a mobile device, for example. The candidate computer device 172 may access and communicate with the job posting websites and other job boards and channels over a network, such as the Internet or an intranet. As such, the candidate computer device 172 operates as a client and may be referred to a client computer (e.g., it is a client of the web server hosting the websites). While one candidate computer device 172 is shown in FIG. 1, there may be thousands of other candidates using other computer devices to access the job posting websites, job boards, and other job posting channels.

The recruiting system 150 may obtain the job posting data stored in the job posting database 150 and use it to train and test a machine learning model. The machine learning model may be a prediction model that is trained using a machine learning algorithm. The recruiting system 150 may use the prediction model to predict the best dates and times for a particular job advertisement to be posted based on a date, time, country, and business segment, as further described below.

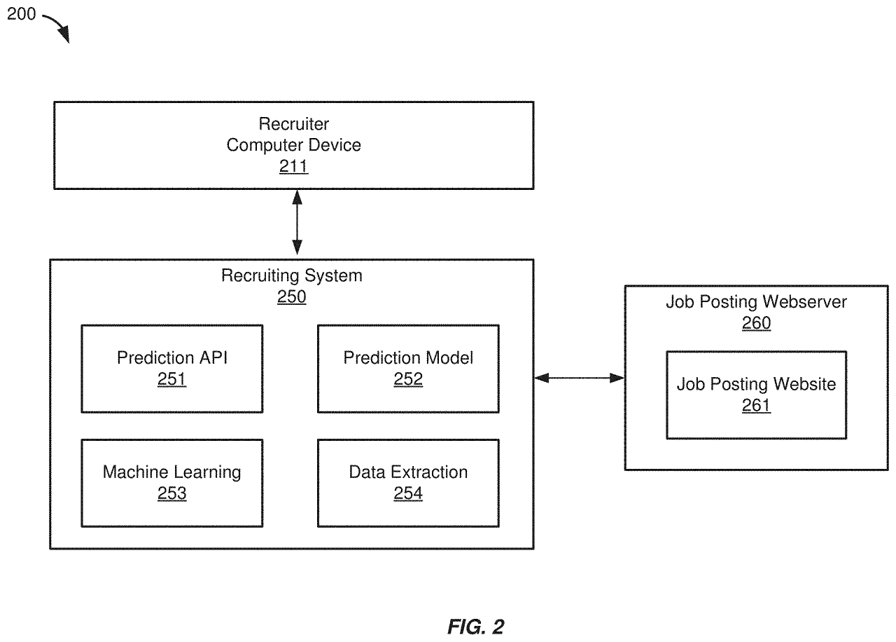

FIG. 2 shows a diagram 200 of a recruiter computer device 221, a job posting webserver 260, and components of a recruiting system 250, according to an embodiment. The recruiter computer device 221 may be configured similar to the recruiter computer device 111 described above with respect to FIG. 1. The recruiting system 250 may be configured similar to the recruiting system 150 described above with respect to FIG. 1. The job posting webserver 260 may host a job posting website 261. The job posting website 261 may be configured and used similar to the job posting websites 161, 162, 163 described above with respect to FIG. 1. The job posting webserver 160 may be configured similar to the one or more webservers hosting the job posting websites 161, 162, 163 described above with respect to FIG. 1.

The recruiting system 250 may include a prediction application programming interface (API) component 251, a prediction model 252, a machine learning component 253, and a data extraction component 254. These components 251, 252, 253, and 254 may be implemented in software using computer program code and data stored at the recruiting system 250, for example.

The prediction API 251 may be configured to receive requests or queries for predicted dates and times from a recruiter computing device, a client computer, or other computer devices. The request messages may indicate or include a request date and a request time. In some embodiments, the request date and the request time may be a current date and time, or they may be a date and time proposed by a user (e.g., the recruiter using the recruiter computer device). In some embodiments, the request may further include a request day-of-year, an indicator or identifier of a country, and an indicator or identifier of a business segment. The business segment indicator may indicate technology, manufacturing, banking, or other industries, both specific and general, for example. The prediction API 251 may apply the information obtained from the request (e.g., the request date, the request time, the request day-of-year, the country indicator, and the business segment indicator) as input to the prediction model 252 to obtain output or results from the prediction model 252. The output or results of the prediction model 252 may include a predicted date and a predicted time. The output or results may also include a predicted day-of-year. The predicted date and time output by the prediction model 252 is a prediction of when candidates would view a job posting that was posted on the request date, at the request date, for the country and business segment indicated.

Accordingly, instead of posting the job advertisement at the query date and time, the job advertisement may be posted at the predicted date and time. If the day-of-year, which may indicate a particular season or quarter, is predicted then the posting of the advertisement or an additional posting of the advertisement may also be based on the predicted day-of-year. As such, the job posting may be more recently posted when the candidates are predicted to view the job websites or boards, and therefore higher up in the ordering or ranking or jobs presented to candidates browsing or searching the job website or board. Advantageously, job advertisements posted at the predicted date and time, or based on, or offset from, the predicted date and may receive additional views compared to what the job posting would have received if it had been posted at another time (e.g., at the query date and time), thereby enabling the recruiter to better find the best candidate for the job.

In some embodiments, the predicted date and time may be sent to the recruiter computer device 211 such that a user of the recruiter computer device 211 may post a job advertisement on the job posting website 261, for example. In some embodiments the predicted date and time may be used by the recruiting system 250 to post a job advertisement on the job posting website 261, for example.

As discussed above, the prediction model 252 may be trained and tested using machine learning. The machine learning component 253 may be configured to generate the prediction model, train the prediction model, test the prediction model, and validate the prediction model as further described below. A validated prediction model may be deployed for use by the recruiting system 250 prediction API 251. The prediction model 252 may be generating using a machine learning algorithm, which may be based on a linear regression algorithm, for example. The machine learning algorithm may use a multivariate linear regression with parameters determined in a training phase and hyperparameters (e.g., learning rate) determined in a testing phase.

The data extraction module 254 may obtain data to use for training, testing, and validating the machine learning models. The data may be obtained from a job posting database, such as the job posting database 180 described above. For example, job posting information or data may queried or otherwise obtained and then the data extraction module 254 may extract post records and view records corresponding to the post records from the job posting information. The post records may include a post date, a post time, a country indicator, and a segment indicator for each of a plurality of job postings. The view records may include a view date and a view time for each of the plurality of job postings

The machine learning algorithm and the training, testing, and validation of the prediction module are further described below.

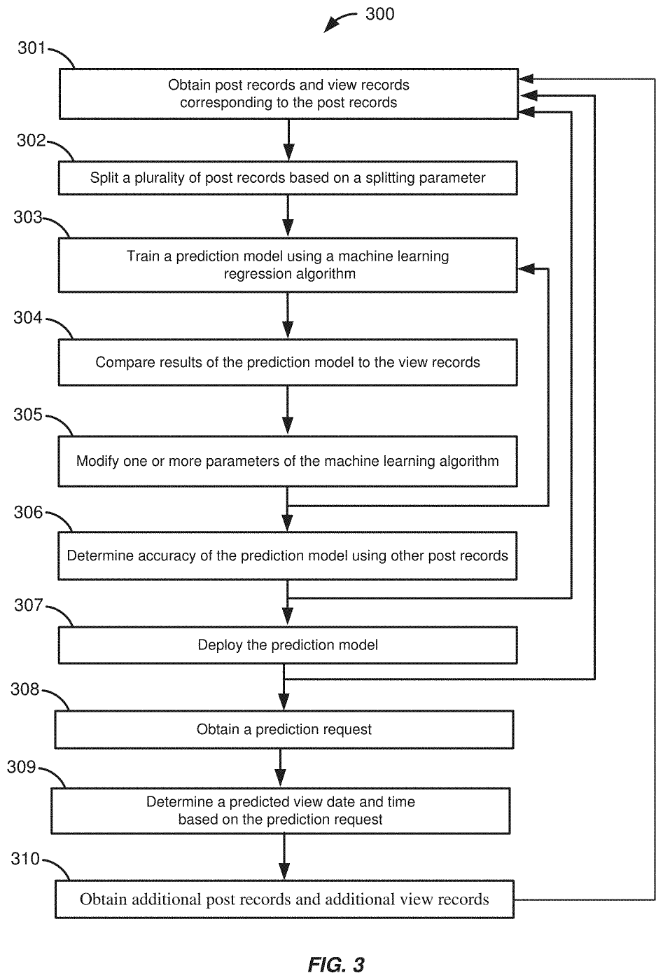

FIG. 3 shows a flowchart 300 of a method for training a machine learning model, predicting job post view dates and times, and updating the model, according to an embodiment. The method of FIG. 3 may be performed or implemented by a recruiting system, such as the recruiting system 150 of FIG. 1 or the recruiting system 250 of FIG. 2. In some embodiments of the method, the actions or functions may be performed in a different order, or they may be optionally left out, or they may be repeated, as consistent with the description below.

At 301, the method obtains post records and view records corresponding to the post records. As described herein, the post records and corresponding view records may be obtained from a job posting database. The obtained post records and corresponding view records may include all obtained records or the obtained post records may be sampled or selected from a larger set of post records or information.

At 302, the method splits a plurality of post records based on a splitting parameter. For example, the splitting parameter may indicate that 80% of post records will be used for training of the machine learning model while 20% of the post records will be used for testing of the machine learning model. In another example, the splitting parameter may indicate that 70% of post records will be used for training of the machine learning model while 30% of the post records will be used for testing of the machine learning model. In other embodiments, the splitting parameter may indicate a different split.

At 303, the method trains a prediction model using a machine learning algorithm. In some embodiments, the machine learning algorithm may be based on a linear regression algorithm. The training of the machine learning model uses the post records and view records as input to “fit” the model, setting the model parameters (e.g., the parameters of the linear regression algorithm).

At 304, the method compares results of the prediction model to the view records. This comparison may be performed as part of testing the machine learning model. Testing of the model may use the second (other) split of the post records not used for training as input to the training machine learning model. The results are compared to the corresponding view results in order to determine the how well the machine learning model is performed.

At 305, the method modifies one or more parameters of the machine learning algorithm. The comparisons performed during testing of the machine learning model may be used to set hyperparameters (e.g., learning rate) for re-training the model. The testing of the model and the resulting retraining of the model using different hyperparameters may prevent overfitting of the model to the training data. In some cases, the modifying of the parameters at 305 may be skipped if the testing phase is complete. After modifying the hyperparameters, the method may return to 303 to retrain the prediction model using the modified hyperparameters.

At 306, the method determines accuracy of the prediction model using other post records. This determination may be performed as part of a validation phase, after the machine learning model has been trained and tested. The accuracy may be based on view records for other post records, such as new post records or post records that are different from those used during the training and testing phases. If the accuracy of the prediction model does not meet certain predetermined accuracy criteria, then the method may return to 301 and obtain a different set of post records and corresponding view records and begin training a new machine learning model.

At 307, the method deploys the prediction model. The model may be deployed if it meets certain accuracy criteria. New machine learning models may be generating (e.g., trained, tested, and validated) according to a schedule (e.g., every week or every two weeks) and then the new machine learning model may be deployed.

At 308, the method obtains a prediction request. The prediction request may be obtained via a prediction API, as described herein. The prediction request may include a request date, a request time, a request day-of-year, a country indicator, and a business segment indicator.

At 309, the method determines a predicted view date and time based on the prediction request. The predicted view date and predicted view time may be determined by applying (e.g., inputting) the request date, the request time, the request day-of-year, the country indicator, and the business segment indicator to the deployed machine learning model.

At 310, the method obtains additional post records and additional view records. The post records and view records may be determined based on new or different job postings. For example, they may be based on job postings created after the prediction model has been deployed. The additional post records and corresponding additional view records may be used in training and testing further machine learning models.

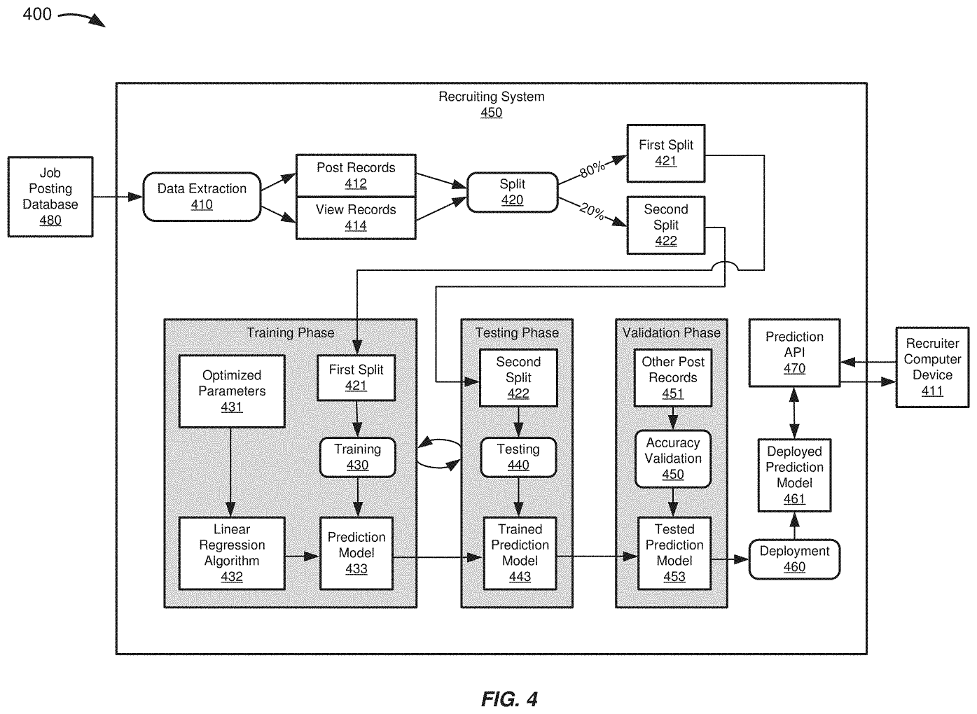

FIG. 4 shows a diagram 400 of training, testing, and validating of a machine learning model, according to an embodiment. The training, testing, and validating of the machine learning model may be performed by a recruiting system 450, as shown in FIG. 4. In some embodiments, the training and testing of the machine learning model may be performed by a different computer system and the final validated model may be provided to the recruiting system 450.

As described above, job posting information may be obtained from a job posting database 480. Data extraction 410 may be performed in order to determine or obtain the post records 412 and the view records 414 corresponding to the post records 412. In some embodiments, the job posting information stored in the job posting database 480 may be formatted as post records and view records. The post records 412 may include a post date, a post time, a day-of-year, a country indicator, and a segment indicator for each of a plurality of job postings and the view records 414 may include a view date and a view time for each of the plurality of job postings.

The post records 412 may be split 420 based on a splitting parameters. As shown in FIG. 4, a splitting parameter may split 80% the post records 412 into a first split 421 and the remaining 20% of the post records 414 into a second split 422. The first split 421 of the post records 412 and a first portion of view records 414 which correspond to the first split 421 may be used in a training phase while the second split 422 of the post records 414 and a second portion of the view records 414 which correspond to the second split 422 may be used in a testing phase.

In the training phase, the machine learning algorithm optimizes the best parameter through the model. For instance, in the training phase, optimized parameters 431 for a linear regression algorithm 432 are used to determine a prediction model 433 by using a machine learning algorithm to perform training 430 of the first split 421 of the post records 412 and the second portion of the view records 414 which correspond to the second split 422. Training 430 of the prediction model 422 using the machine learning algorithm may include fitting parameters of the prediction model 433 to the input data (i.e., the first split 421 of the post records and the corresponding view records).

In the testing phase, the trained model may be tested by calculating a specific score for the model. For instance, during the testing phase the second split 422 may be used for testing 440 of the trained prediction model 443. Testing 440 may include using gradient descent to determine or update the parameters of the linear regression algorithm used in the prediction model in order to minimize a cost function (e.g., minimizing the error between the linear equation and the view records). After testing 440, the prediction model 442 may be retraining in another training phase, and then tested in another testing phase, depending on the parameters of the machine learning algorithm.

The validation phase may include a functional test of the trained and tested machine learning model. For instance, during the validation phase other post records 451 are used in accuracy validation 450 of the tested prediction model 453. The other post records 451 are different from the first split 421 and the second split 422 used in training and testing of the prediction model. The accuracy of the tested prediction model 453 may be compared to a predetermined accuracy threshold, for example. If the accuracy validation 450 is successful, the validated prediction model 461 may be deployed 460 for use with a prediction API 470. As described above, a recruiter computer device 411 or another client computer device may send requests to the recruiting system for predicted dates and times at which candidates may view a particular job posting such that recruiters may post the job advertisement based on the predicted date and time. The prediction request received from the recruiter computer device 411 may include a request date, a request time, a request day-of-year, a country indicator, and a business segment indicator. The request date, the request time, the request day-of-year, the country indicator, and the business segment indicator may be applied to the deployed prediction model 461 as input, and the model may provide a predicted date, a predicted time, and a predicted day-of-year as output. In some embodiments, the predicted date, the predicted time, and the predicted day-of-year may be provided back to the recruiter computer device 411 in a response message. In some embodiments, the predicted date and the predicted time may be used by the recruiting system 450 to post a job advertisement provided by the recruiter computer device 411.

As described above, the recruiting system can provide an API for predicting dates and times that recruiters may use for posting job advertisements. The predicted dates and times are determined using a machine learning model, instead of using a statistical model, as described herein. Features and advantages of training a model using machine learning algorithms is that the machine learning model may accurately be used for prediction, unlike statistical models which merely reflect the characteristics of the input data and may have poor prediction accuracy due to overfitting, for example. Other features and advantages of using a prediction model trained using a machine learning algorithm, compared to statistical models, is that the prediction model may account for changes overtime, thereby accounting for upwards or downwards trends. As such, the recruiting system enables recruiters to post job advertisements at times when candidates are predicted to be viewing job advertisements such that they may find better fit candidates for the job.

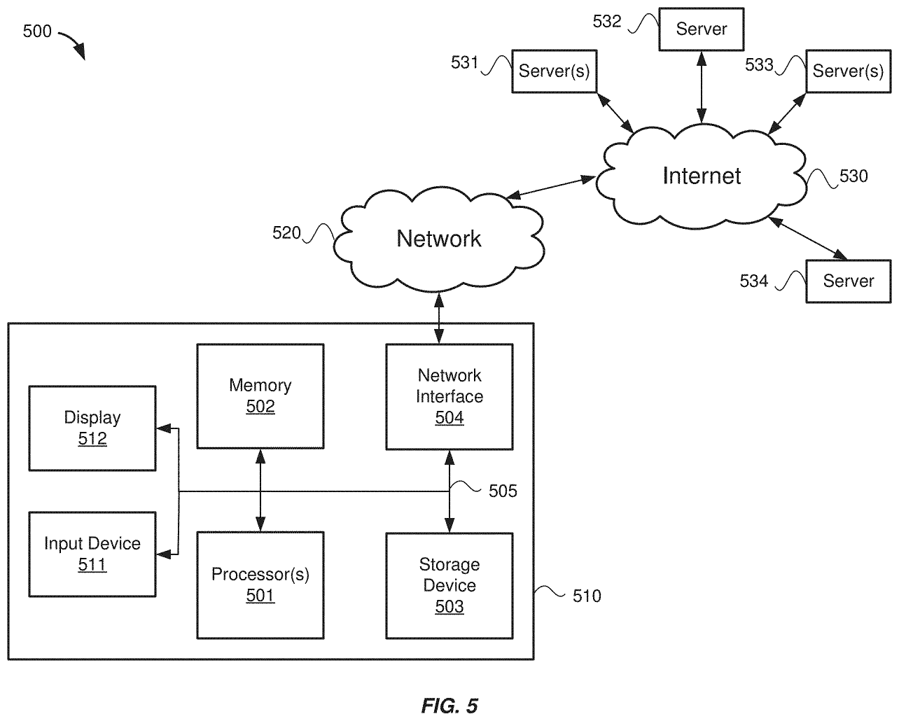

FIG. 5 shows a diagram 500 of hardware of a special purpose computing machine for implementing systems and methods described herein. The following hardware description is merely one example. It is to be understood that a variety of computers topologies may be used to implement the above described techniques. The hardware shown in FIG. 5 is specifically configured to implement the recruiter system described herein.

A computer system 510 is illustrated in FIG. 5. The computer system 510 includes a bus 505 or other communication mechanism for communicating information, and one or more processors 501 coupled with bus 505 for processing information. The computer system 510 also includes a memory 502 coupled to bus 505 for storing information and instructions to be executed by processor 501, including information and instructions for performing some of the techniques described above, for example. This memory may also be used for storing programs executed by processor(s) 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 503 may include source code, binary code, or software files for performing the techniques above, such as the method described above with respect to FIG. 3, for example. Storage device and memory are both examples of non-transitory computer readable storage mediums.

The computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses, for example.

The computer system also includes a network interface 504 coupled with bus 505. The network interface 504 may provide two-way data communication between computer system 610 and a network 520. The network interface 504 may be a wireless or wired connection, for example. The computer system 510 can send and receive information through the network interface 504 across a local area network, an Intranet, a cellular network, or the Internet, for example. In the Internet example, a browser, for example, may access data and features on backend systems that may reside on multiple different hardware servers 531-534 across the network. The servers 531-534 may be part of a cloud computing environment, for example.

Additional embodiments of the present disclosure are further described below.

One embodiment provides a computer system comprising one or more processors and one or more machine-readable medium. The one or more machine-readable medium are coupled to the one or more processors. The one or more machine-readable medium store computer program code comprising sets of instructions executable by the one or more processors. The instructions are executable by the one or more processors to obtain a prediction request including a request date, a request time, a request day-of-year, a country indicator, and a business segment indicator. The instructions are further executable by the one or more processors to determine a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records include a view date and a view time for each of the plurality of job postings.

In some embodiments of the computer system, the computer program code may further comprise sets of instructions to send a job posting request to a web server based on the predicted date and the predicted time.

In some embodiments of the computer system, the computer program code may further comprise sets of instructions to receive the prediction request from a client computer and send a prediction response to the client computer including the predicted date, the predicted time, and the predicted day-of-year.

In some embodiments of the computer system, the computer program code may further comprise sets of instructions to compare results of the prediction model using a second split of the post records to the view records corresponding to the second split of the post records and modify one or more parameters of the machine learning algorithm based on the comparison of the results to the view records corresponding to the second split of the post records.

In some embodiments of the computer system, the computer program code may further comprise sets of instructions to obtain additional post records and additional view records corresponding to the additional post records, the additional post records corresponding to job postings submitted based on dates and times output by the prediction model. In such embodiments, the computer program code may further comprise sets of instructions to train the prediction model using the machine learning algorithm based on the additional post records and the additional view records corresponding to the additional post records.

In some embodiments of the computer system, the computer program code may further comprises sets of instructions split the plurality of post records based on a splitting parameter into the first split of the plurality of post records for training of the prediction model and a second split of the plurality of post records for testing of the prediction model. In such embodiments, the computer program code may further comprise sets of instructions train the prediction model trained using the machine learning algorithm based on the first split of the plurality of post records.

In some embodiments of the computer system, the machine learning algorithm is based on a linear regression algorithm.

Another embodiment provides one or more non-transitory computer-readable medium storing computer program code comprising sets of instructions. The computer program code comprising instructions to obtain a prediction request including a request date, a request time, a request day-of-year, a country indicator, and a business segment indicator. The computer program code further comprises sets of instructions to determine a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records include a view date and a view time for each of the plurality of job postings.

In some embodiments, the computer program code may further comprise sets of instructions to send a job posting request to a web server based on the predicted date and the predicted time.

In some embodiments, the computer program code may further comprise sets of instructions to receive the prediction request from a client computer and send a prediction response to the client computer including the predicted date, the predicted time, and the predicted day-of-year.

In some embodiments, the computer program code may further comprise sets of instructions to compare results of the prediction model using a second split of the post records to the view records corresponding to the second split of the post records and modify one or more parameters of the machine learning algorithm based on the comparison of the results to the view records corresponding to the second split of the post records.

In some embodiments, the computer program code may further comprise sets of instructions to obtain additional post records and additional view records corresponding to the additional post records, the additional post records corresponding to job postings submitted based on dates and times output by the prediction model. In such embodiments, the computer program code may further comprise sets of instructions to train the prediction model using the machine learning algorithm based on the additional post records and the additional view records corresponding to the additional post records.

In some embodiments, the computer program code may further comprise sets of instructions to split the plurality of post records based on a splitting parameter into the first split of the plurality of post records for training of the prediction model and a second split of the plurality of post records for testing of the prediction model. In such embodiments, the computer program code may further comprise sets of instructions to train the prediction model trained using the machine learning algorithm based on the first split of the plurality of post records.

In some embodiments, the machine learning algorithm is based on a linear regression algorithm.

Another embodiment provides a computer-implemented method. The method includes obtaining a prediction request including a request date, a request time, a request day-of-year, a country indicator, and a business segment indicator. The method further includes determining a predicted date, a predicted time, and a predicted day-of-year by applying the request date, the request time, the request day-of-year, the request country indicator, and the business segment indicator to a prediction model. The prediction model being trained using a machine learning algorithm based on a first split of a plurality of post records and first view records of a plurality of view records corresponding to the first split of the post records. The post records include a post date, a post time, a country indicator, and a segment indicator for each of a plurality of job postings and the view records including a view date and a view time for each of the plurality of job postings.

In some embodiments, the computer-implemented method may further comprise sending a job posting request to a web server based on the predicted date and the predicted time.

In some embodiments, the computer-implemented method may further comprise receiving the prediction request from a client computer and sending a prediction response to the client computer including the predicted date, the predicted time, and the predicted day-of-year.

In some embodiments, the computer-implemented method may further comprise comparing results of the prediction model using a second split of the post records to the view records corresponding to the second split of the post records. In such embodiments, the computer-implemented method may further comprise modifying one or more parameters of the machine learning algorithm based on the comparison of the results to the view records corresponding to the second split of the post records.

In some embodiments, the computer-implemented method may further comprise obtaining additional post records and additional view records corresponding to the additional post records, the additional post records corresponding to job postings submitted based on dates and times output by the prediction model. In such embodiments, the computer-implemented method may further comprise training the prediction model using the machine learning algorithm based on the additional post records and the additional view records corresponding to the additional post records.

In some embodiments, the computer-implemented method may further comprise splitting the plurality of post records based on a splitting parameter into the first split of the plurality of post records for training of the prediction model and a second split of the plurality of post records for testing of the prediction model. In such embodiments, the computer-implemented method may further comprise training the prediction model trained using the machine learning algorithm based on the first split of the plurality of post records.

In some embodiments, the machine learning algorithm is based on a linear regression algorithm.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

As used herein, the terms “first,” “second,” “third,” “fourth,” “fifth,” “sixth,” “seventh,” “eighth,” “ninth,” “tenth,” etc., do not necessarily indicate an ordering or sequence unless indicated. These terms, as used herein, may simply be used for differentiation between different objects or elements.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A computer system, comprising:
one or more processors; and
one or more machine-readable medium coupled to the one or more processors and storing computer program code comprising sets of instructions executable by the one or more processors to:
obtain a prediction request including a request date, a request time, a request day-of-year, a country indicator, and a business segment indicator; and
determine a predicted date, a predicted time, and a predicted day-of-year by applying the request date, the request time, the request day-of-year, the request country indicator, and the business segment indicator to a prediction model trained using a machine learning algorithm based on a first split of a plurality of post records and first view records of a plurality of view records corresponding to the first split of the post records, the post records including a post date, a post time, a country indicator, and a segment indicator for each of a plurality of job postings, the view records including a view date and a view time for each of the plurality of job postings.

2. The computer system of claim 1, wherein the computer program code further comprises sets of instructions executable by the one or more processors to:
send a job posting request to a web server based on the predicted date and the predicted time.

3. The computer system of claim 1, wherein the computer program code further comprises sets of instructions executable by the one or more processors to:
receive the prediction request from a client computer; and
send a prediction response to the client computer including the predicted date, the predicted time, and the predicted day-of-year.

4. The computer system of claim 1, wherein the computer program code further comprises sets of instructions executable by the one or more processors to:
compare results of the prediction model using a second split of the post records to the view records corresponding to the second split of the post records; and
modify one or more parameters of the machine learning algorithm based on the comparison of the results to the view records corresponding to the second split of the post records.

5. The computer system of claim 1, wherein the computer program code further comprises sets of instructions executable by the one or more processors to:
obtain additional post records and additional view records corresponding to the additional post records, the additional post records corresponding to job postings submitted based on dates and times output by the prediction model; and
train the prediction model using the machine learning algorithm based on the additional post records and the additional view records corresponding to the additional post records.

6. The computer system of claim 1, wherein the computer program code further comprises sets of instructions executable by the one or more processors to:
split the plurality of post records based on a splitting parameter into the first split of the plurality of post records for training of the prediction model and a second split of the plurality of post records for testing of the prediction model; and
train the prediction model trained using the machine learning algorithm based on the first split of the plurality of post records.

7. The computer system of claim 1, wherein the machine learning algorithm is based on a linear regression algorithm.

8. One or more non-transitory computer-readable medium storing computer program code comprising sets of instructions to:
obtain a prediction request including a request date, a request time, a request day-of-year, a country indicator, and a business segment indicator; and
determine a predicted date, a predicted time, and a predicted day-of-year by applying the request date, the request time, the request day-of-year, the request country indicator, and the business segment indicator to a prediction model trained using a machine learning algorithm based on a first split of a plurality of post records and first view records of a plurality of view records corresponding to the first split of the post records, the post records including a post date, a post time, a country indicator, and a segment indicator for each of a plurality of job postings, the view records including a view date and a view time for each of the plurality of job postings.

9. The non-transitory computer-readable medium of claim 8, wherein the computer program code further comprises sets of instructions executable by the one or more processors to:
send a job posting request to a web server based on the predicted date and the predicted time.

10. The non-transitory computer-readable medium of claim 8, wherein the computer program code further comprises sets of instructions executable by the one or more processors to:
receive the prediction request from a client computer; and
send a prediction response to the client computer including the predicted date, the predicted time, and the predicted day-of-year.

11. The non-transitory computer-readable medium of claim 8, wherein the computer program code further comprises sets of instructions executable by the one or more processors to:
compare results of the prediction model using a second split of the post records to the view records corresponding to the second split of the post records; and
modify one or more parameters of the machine learning algorithm based on the comparison of the results to the view records corresponding to the second split of the post records.

12. The non-transitory computer-readable medium of claim 8, wherein the computer program code further comprises sets of instructions executable by the one or more processors to:
obtain additional post records and additional view records corresponding to the additional post records, the additional post records corresponding to job postings submitted based on dates and times output by the prediction model; and
train the prediction model using the machine learning algorithm based on the additional post records and the additional view records corresponding to the additional post records.

13. The non-transitory computer-readable medium of claim 8, wherein the computer program code further comprises sets of instructions executable by the one or more processors to:
split the plurality of post records based on a splitting parameter into the first split of the plurality of post records for training of the prediction model and a second split of the plurality of post records for testing of the prediction model; and
train the prediction model trained using the machine learning algorithm based on the first split of the plurality of post records.

14. The non-transitory computer-readable medium of claim 8, wherein the machine learning algorithm is based on a linear regression algorithm.

15. A computer-implemented method, comprising:
obtaining a prediction request including a request date, a request time, a request day-of-year, a country indicator, and a business segment indicator; and
determining a predicted date, a predicted time, and a predicted day-of-year by applying the request date, the request time, the request day-of-year, the request country indicator, and the business segment indicator to a prediction model trained using a machine learning algorithm based on a first split of a plurality of post records and first view records of a plurality of view records corresponding to the first split of the post records, the post records including a post date, a post time, a country indicator, and a segment indicator for each of a plurality of job postings, the view records including a view date and a view time for each of the plurality of job postings.

16. The computer-implemented method of claim 15, further comprising:
sending a job posting request to a web server based on the predicted date and the predicted time.

17. The computer-implemented method of claim 15, further comprising:
receiving the prediction request from a client computer; and
sending a prediction response to the client computer including the predicted date, the predicted time, and the predicted day-of-year.

18. The computer-implemented method of claim 15, further comprising:
comparing results of the prediction model using a second split of the post records to the view records corresponding to the second split of the post records; and
modifying one or more parameters of the machine learning algorithm based on the comparison of the results to the view records corresponding to the second split of the post records.

19. The computer-implemented method of claim 15, further comprising:
obtaining additional post records and additional view records corresponding to the additional post records, the additional post records corresponding to job postings submitted based on dates and times output by the prediction model; and
training the prediction model using the machine learning algorithm based on the additional post records and the additional view records corresponding to the additional post records.

20. The computer-implemented method of claim 15, further comprising:
splitting the plurality of post records based on a splitting parameter into the first split of the plurality of post records for training of the prediction model and a second split of the plurality of post records for testing of the prediction model; and
training the prediction model trained using the machine learning algorithm based on the first split of the plurality of post records.
